(19) United States
(12) Patent Application Publication
(10) Pub. No.: US 2005/0034124 A1
(43) Pub. Date: Feb. 10, 2005

(54) Mechanism for simultaneously operating multiple applications on a personal digital assistant implementing a palm operating system

(76) Inventors: Eric Edward House, Emeryville, CA (US); Lee Ryan Taylor, Braintree, MA (US); Christopher Alan Mitra, Palo Alto, CA (US); Vinay Shashikumar Badami, Sunnyvale, CA (US); Glen Michael Allison, San Jose, CA (US)

Correspondence Address: BLAKELY, SOKOLOFF, TAYLOR & ZAFMAN LLP;Seventh Floor, 12400 Wilshire Boulevard, Los Angeles, CA, 90025-1026, US

(21) Appl. No.: 10/400,973

(22) Filed: Mar. 27, 2003

(51) Int. Cl. G06F 9/46

(52) U.S. Cl. 718/100

(57) ABSTRACT

According to one embodiment, a method is disclosed. The method includes launching a first application on a handheld device implementing a Palm Operating System (OS), and launching a second application. The second application is a time dependent application that runs in the background of the first application.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### FIELD OF THE INVENTION

The present invention relates to the field of handheld computing devices; more particularly, the present invention relates to operating systems for handheld computing devices.

### BACKGROUND

The popularity and use of Personal Digital Assistants (PDAs) has increased in recent years. A PDA or hand-held computer is primarily a lightweight, compact productivity and communications tool that can typically be held in one hand, leaving the other hand free to input data with a pen type stylus or a reduced size keyboard. A PDA provides computing and information storage and retrieval capabilities for personal or business use.

Typical uses include schedule and address book storage and retrieval, as well as note taking functions. In addition, many PDAs are capable of running a variety of application software packages (e.g., calculators, text and/or image editors, etc.). Moreover, many existing PDAs offer the ability to transmit and receive messages, as well as access the Internet.

The Palm Operating System, developed by PalmSource, Inc. of Sunnyvale, Calif., is implemented in a vast number of the PDAs and wireless devices currently available. However, a problem with PDAs using the Palm Operating System is (PalmOS )that only one thread is capable of running at any one time. Since in the PalmOS there is only one thread per application, only one application is cable of operating at any given time. Thus, when a particular application is to be used, the application is launched, but must be shut down prior to opening a second application.

On exit, the application must explicitly save any state it wants to preserve. The form in which the state is saved will typically differ from the form it takes when the application is running. Since this is very different from the way applications work on most platforms it presents a special challenge to computer programmers adapting (“porting”) software written for other platforms to PalmOS.

For example, if a user is currently using a calculator application and wishes to access an address book, the calculator application is shut down before the user opens the address book. Consequently, the runtime state information (e.g., stack, register values and global variables) for the calculator application is erased as it is shut down. With typical non-time dependent applications and typical simple data sets, the limitation of operating only one application at a time is not a critical drawback.

However, time dependent applications for the Palm Operating System are currently being developed. Such time dependent applications will not be effective if it is necessary to close down upon opening another application. In addition, time dependent applications cannot provide a user experience including acceptably quick transitions if the applications had to save and load all states at each start/stop. Therefore, a PDA implementing a Palm Operating System that is capable of simultaneously running multiple applications is desired.

### SUMMARY

According to one embodiment, a method is disclosed. The method includes launching a first application on a handheld device implementing a Palm Operating System (OS), and launching a second application. The second application is a time dependent application that runs in the background of the first application.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates one embodiment of a handheld device;

FIG. 2 illustrates a block diagram of one embodiment of a handheld device;

FIG. 3 illustrates a block diagram of one embodiment of a time dependent application to operate on a handheld device;

FIG. 4 illustrates a block diagram of one embodiment of components implemented to enable a time dependent application;

FIG. 5 illustrates a flow diagram for one embodiment of the operation of a time dependent application; and

FIGS. 6A and 6B illustrate one embodiment of a flow diagram for one embodiment of simultaneously operating multiple applications on a handheld device.

### DETAILED DESCRIPTION

According to one embodiment, a method for simultaneously operating multiple applications on a handheld device is described. In the following description, numerous details are set forth. At first a time dependent application is launched and exited. Subsequently, a second application is launched.

The time dependent application is launched by the OS as a result of a time dependent event (such as an incoming SMS message) or as a result of the expiration of an OS timer previously set. In either of these cases the OS will call the time dependent application, but will not provide the application with the global state (global variables, inter-segment jump tables, etc.) ordinarily given to applications launched in the foreground.

Having earlier saved its own copy of that global state, the time dependent application is able to switch to that state and then run exactly as if launched in the foreground (e.g., running computer code written without taking PalmOS's limitations into account). After a short time (but of its own choosing), the application removes the global state changes it made and returns control to the OS, which can then return control to the foreground application without it being apparent to the user that that foreground application every ceased to run.

While the time dependent application continues not to be the foreground application, the time dependent application also continues to schedule itself to be launched by the OS by setting timers each time it returns from having been launched in the background. The length of time after which the time dependent application asks to be launched depends on how much work remains to be scheduled.

If there is work to be done the time dependent application may ask to be launched quickly. If there is no work to be scheduled, but there is a network connection available, the time dependent application may not request to be launched for a number of seconds. If there is no network, the time dependent application may not request to be launched again at all, instead waiting for an external event such as the arrival of an NBS message, or user activity causing it to be launched in the foreground, before doing any further work.

However, each time the time dependent application is launched, whether in the foreground or background, the time dependent application sets up, uses, and disengages from, the same global state so that changes made during one launch are available during subsequent launches. The time dependent application does this without there having been any changes made to the code in porting to PalmOS.

It will be apparent, however, to one skilled in the art, that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art.

An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

The instructions of the programming language(s) may be executed by one or more processing devices (e.g., processors, controllers, control processing units (CPUs), execution cores, etc.).

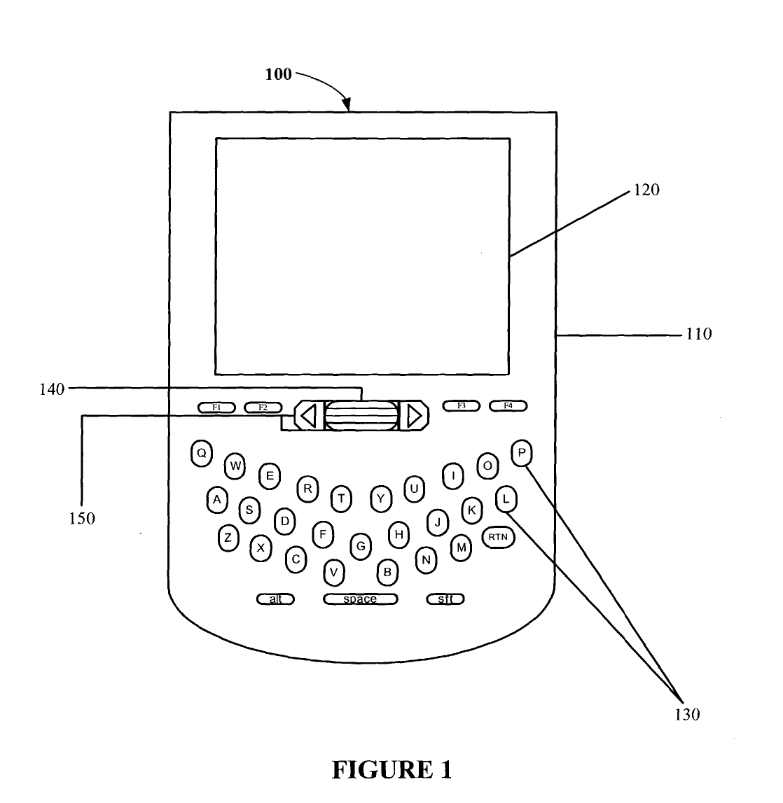

FIG. 1 illustrates one embodiment of a handheld device 100. According to one embodiment, handheld device 100 is a wireless handheld device. In another embodiment, device 100 is a personal digital assistant (PDA). In yet another embodiment, handheld device 100 is a two-way pager. In another embodiment, handheld offers the ability to wirelessly transmit and receive electronic-mail (e-mail) messages, calendar events, contact lists, etc. In yet a further embodiment, handheld device 100 operates using the Palm Operating System (PalmOS).

Handheld device 100 includes a housing 110, display 120, keyboard 130, thumbwheel 140, navigation buttons 150, and light sensor 160. Display 120 is mounted within housing 110. Display 120 is a projecting mechanism that shows text and graphic images to a device 100 user. In one embodiment, display 120 is implemented with a liquid crystal display (LCD). However, one of ordinary skill in the art will appreciate that display 120 may be implemented using other image projection technology.

Keyboard 130 is mounted on housing 110, and is the primary text input device for device 100. Keyboard includes the standard arrangement of alphabetic keys (e.g., the QWERTY keyboard). Also, in one embodiment, keyboard 130 includes function keys F1-F4.

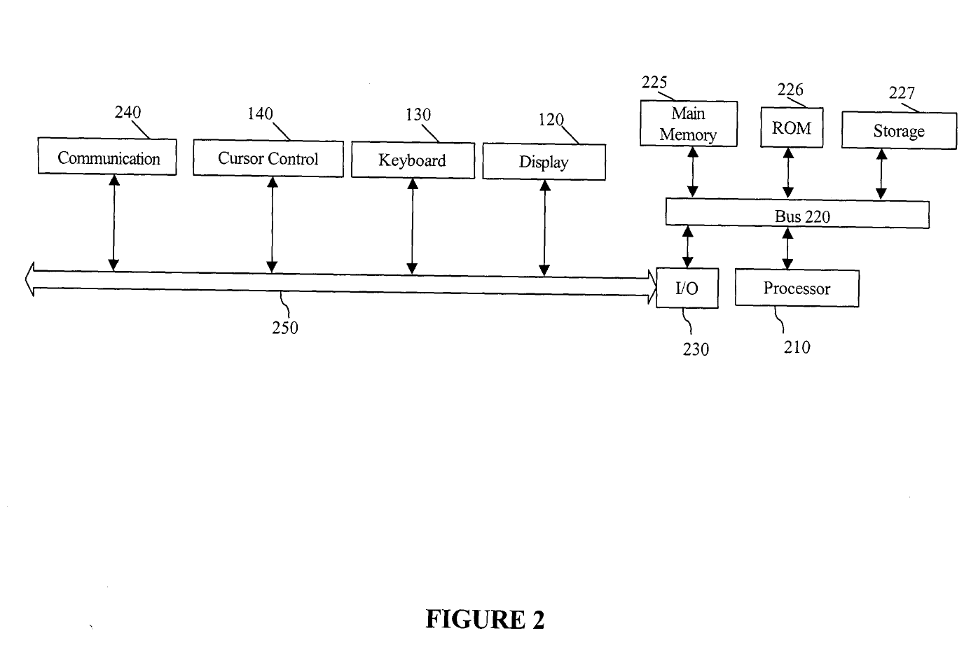

FIG. 2 illustrates a computer system 200 on which handheld device 100 is implemented. Computer system 200 includes a system bus 220 for communicating information, and a processor 210 coupled to bus 220 for processing information. According to one embodiment, processor 210 is implemented using one of the multitude of Motorola DragonBall MC68328-family of microprocessors. Nevertheless one of ordinary skill in the art will appreciate that other processors may be used.

Computer system 200 further comprises a random access memory (RAM) or other dynamic storage device 225 (referred to herein as main memory), coupled to bus 220 for storing information and instructions to be executed by processor 210. Main memory 225 also may be used for storing temporary variables or other intermediate information during execution of instructions by processor 210. Computer system 200 also may include a read only memory (ROM) and/or other static storage device 226 coupled to bus 220 for storing static information and instructions used by processor 210.

A data storage device 227 such as a magnetic disk or optical disc and its corresponding drive may also be coupled to computer system 200 for storing information and instructions. Computer system 200 can also be coupled to a second I/O bus 250 via an I/O interface 230. A plurality of I/O devices may be coupled to I/O bus 250, including a display device 120, an input device (e.g., an alphanumeric input device 130 and/or a cursor control device 140). For example, video news clips and related information may be presented to the user on the display device 120.

The communication device 240 is for accessing other computers (servers or clients) via network 210. The communication device 240 may comprise a modem, a network interface card, or other well-known interface device, such as those used for coupling to Ethernet, token ring, or other types of networks.

As described above, handheld device 100 operates using the PalmOS. The PalmOS is an open and modular OS that supports application development by third parties. PalmOS applications are generally single-threaded, event-driven programs. Thus, only one program may run at any given time.

In a PalmOS application, the application's runtime data can live in several places. The data can be a local variable, which means that it is stored in a stack along with function parameters and return addresses. The data may also be global data (e.g., stored in a special chunk of memory called the global space). This memory is allocated out of the program heap when the application starts, and is freed automatically by a compiler/linker when the application exits back to the operating system.

The global space can be in a different location every time program runs. Thus, the compiler and linker do not embed specific memory addresses into the program code for accessing global variables. Instead, the compiler and linker make the code access global data by adding an offset to the value of a register (a4 or a5 in the PalmOS case) and using the computed value to locate the data. These registers are ordinarily set up when the program starts (e.g., when the application is launched as a foreground application), and are not modified by the operating system or by a developer's code from the time the application is launched until it exits.

Each application has a PilotMain function. To launch an application, after setting up the global variables, code provided by the compiler vendor calls PilotMain and sends a launch code. The launch code may specify that the application is to become active and display its user interface (called a “normal launch”), or it may specify that the application should simply perform a small task and exit without displaying its user interface.

The purpose of the PilotMain function is to receive launch codes and respond to them. Once PilotMain is called, the runtime code then starts up the user application and command parameters and flags that it gets from the application information block are passed in. The user's application has control until it exits. Once the user's application is finished, and before launching another application, the global data for the user's application is erased from the global space in memory. The OS is requested to erase the application data by the vendor-supplied code that is ordinarily linked into the application.

The clearing of global data for one application from the global space prior to launching a subsequent application in the PalmOS currently makes difficult the use of time dependent applications. Time dependent applications are applications that, once launched, need to remain active (e.g., access data) at all times, even when other applications are launched.

According to one embodiment, modifications are made to a compiler vendor's code in a manner that exploits conventions agreed upon by the OS provider and the compiler vendor in order to prevent the erasing of data for a time dependent application when the application is finished.

According to a further embodiment, one or more time dependent applications are configured to enable the PalmOS to run such applications in the background after other applications have been launched and are operating on handheld device 100.

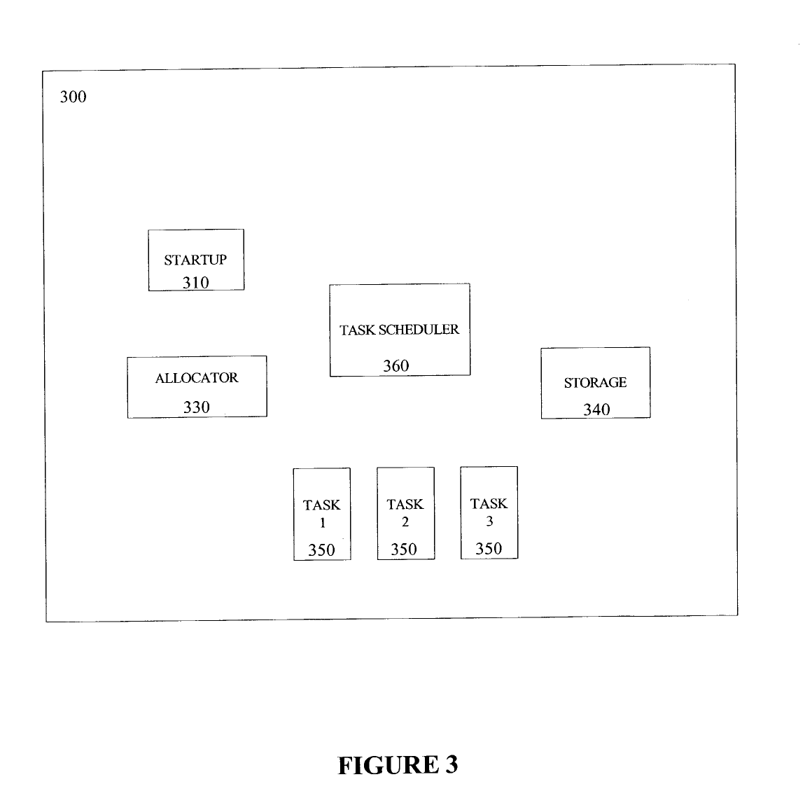

FIG. 3 illustrates a block diagram of one embodiment of a time dependent application 300 that is capable of running in the background of other applications on a handheld device. Application 300 includes startup module 310, allocator 330, storage 340, application tasks 350 and task scheduler 360.

Startup module 310 is used to launch application 300. Typically when the PalmOS launches an application, whether written using the Codewarrior development environment, developed by Metrowerks of Austin, Tex., or open source development tools generally referred to as “prc-tools”, what the OS calls is not code written by the developer but code provided as part of the development environment and linked into the application.

This code interacts with the OS to set up a runtime execution environment that matches the conventions the development environment has compiled the application to expect. For example, if the development environment has compiled code to reference global data via the a5 register, then the startup module will ensure that by the time application code is called register a5 is pointing to its global space.

According to one embodiment, startup module 310 represents modified startup code provided by Metrowerks to enable application 300 to run in the background. In one embodiment, the first time application 300 is launched (which happens as soon as possible after device 100 is reset) space for copies of the application's global worlds is allocated (a4- and a5-relative).

Calls into the OS and startup code are made to cause the compressed initial values of the data in these worlds to be decompressed into our space, and then modified to work correctly at the particular addresses where it now lives. With this accomplished, the global worlds provided to application 300 can be augmented every time it is launched by startup module 310.

If launched “normally” (e.g., in the foreground and with global variables), application 300 uses the previously allocated global worlds instead so that changes made to those worlds will be available on subsequent launches (which would not normally be the case). If application 300 is launched “in the background”, but still via calls to PilotMain, the same global world is provided to the time dependent application. Similarly, if application 300 is launched other than via PilotMain (e.g. through an Alarm or Notification callback where the time dependent application would not ordinarily have access to global variables), the same global worlds are provided.

Allocator 330 allocates space in storage 340 for application 300 upon the application 300 being launched. Storage 340 stores data for application 300. In one embodiment, storage 340 is configured to open in a manner to allow it not to be closed whenever application 300 is operating in the background. Thus, application 300 can operate in the background of a previously launched foreground application. However, during foreground operation all storage opened by an application during one run is closed as soon as it exits.

Tasks 350 are tasks within application 300 that have pending operations to execute and therefore are allowed to run in the background on the PalmOS of handheld device 100. Task scheduler 360 manages the saving and restoring of states in order to enable a task 350 of application 300 to run in the background of another application.

According to one embodiment, scheduler 360 schedules any or all of internal tasks 1-3 to run, counting on them to yield periodically so that other tasks may be scheduled. Moreover, tasks 350 may yield so that the time dependent application may exit to give the PalmOS scheduler (not shown) a chance to run another application. This scheduler 360 function further enables application 300 to run in the background of another application.

The PalmOS scheduler determines what application is to run next, which typically follows the will of the user as expressed in taps in the launcher application. In addition, the PalmOS scheduler “sub-launches” one application for what is meant to be a brief run in the background in response to events such as Alarms (timers) firing. Application 300 may be scheduled by PalmOS in either way.

Once scheduled, application 300 controls the device in the background without a user noticing interruption in the foreground application. After application 300 is given the opportunity by PalmOS to run, application 300 invokes scheduler 360.

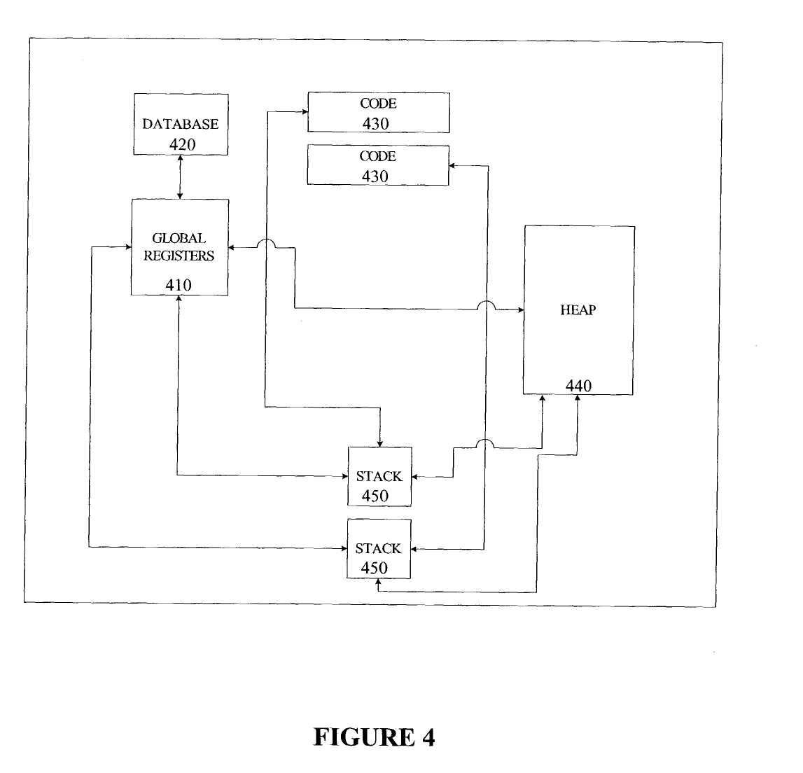

FIG. 4 illustrates a block diagram of one embodiment of the components implemented by task scheduler 360 to enable multiple tasks 350 within application 300 to run simultaneously with a foreground application (e.g., alternating background and foreground states). Referring to FIG. 4, the components include a global register 410, database 420, code 430, heap 440 and stacks 450.

Global register 410 stores global variables used in handheld device 100. In one embodiment, global register 410 is a register (e.g., the a5 register) on processor 210. Database 420 is a collection of objects that are opened by a PalmOS application to read or write data, and obtain references to the open databases, which are used subsequently to reference the databases.

Ordinarily, databases are closed when the application exits PilotMain, and the references become invalid. Should that application on re-launch reopen the database the application would probably receive a different reference. Thus, in one embodiment, the databases are opened with a flag indicating that they should not automatically close on shutdown. Because these references are sometimes stored in global variables that remain valid across launches of a time dependent application, the references also remain valid.

According to one embodiment, the references are kept open by modifying shutdown code provided by the development environment so that the environment does not make PalmOS calls close open databases for the application 300.

Code 430 represents the application 300 program code for each of the implemented tasks 350 of the time dependent application. Heap 440 is an area of pre-reserved memory that is accessed by tasks 350 to store data in some variable amount that is not known until the task 350 is running. A task 350 manages its allocated heap by requesting a chunk of the heap (e.g., a heap block) when needed, and returning the blocks when no longer needed.

As described above with respect to the databases, code resources are referenced by other code (especially on a task's runtime stack) and are not to move as long as the references remain “live”. For ordinary PalmOS applications no reference is live once PilotMain exits. However, because stacks and other reference locations are maintained across application 300 launches it is also ensured that referenced code resources do not move. This is done by locking down all of the code resources for application 300 the first time it is launched. This ensures that the code resources are locked down and do not move. In addition, the “owner ID” of the allocated memory is set to “0”, which indicates that the code resources should not be freed when PilotMain exits.

Stacks 450 are data buffers used to store requests that are to be handled. In one embodiment, there is a stack 450 for each task 350 implemented within application 300. Each stack 450 references global register 410 and heap 440. In addition, stacks 450 reference code 430 for application code resources (e.g., return address).

Further, stacks 450 have a pointer that points into a particular stack depending upon which task 350 is running. In one embodiment, when task scheduler 360 indicates that a task 350 (e.g., task 1) is to yield to another task 350 (e.g., task 2, or to give the PalmOS scheduler), the stack pointer is moved from the stack 450 associated with task 1 to the stack 450 associated with task 2.

As described above, the modified startup/shutdown code of startup module 310 saves the states of the above-described components to enable a task 350 of application 300 to run in the background while another foreground application is running. Particularly, the global variables, stacks 450 for each background task, and the heap for the task are to be locked down. Thus, these objects cannot be automatically or arbitrarily moved by the underlying operating system or other components. In addition, all code for the task 350 is to maintain the same location in memory and all databases are to remain open.

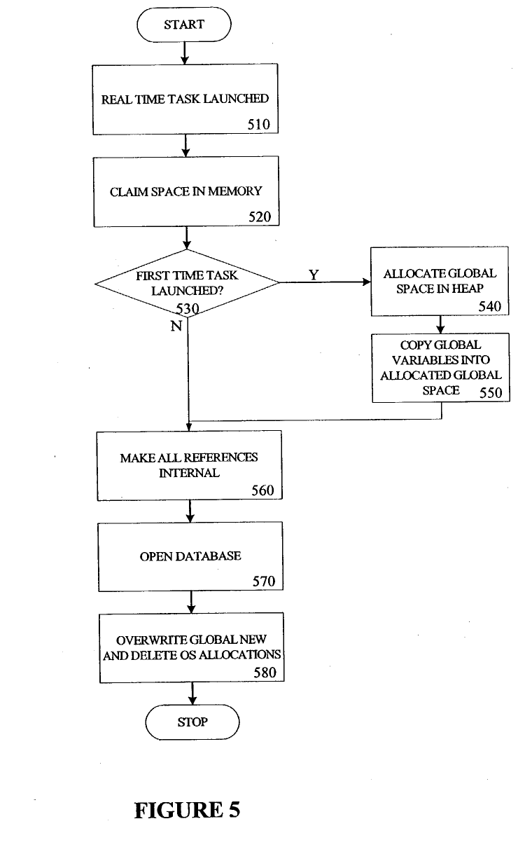

FIG. 5 illustrates a flow diagram for one embodiment of the operation of application 300 to enable background operation. At processing block 510, application 300 is launched. According to one embodiment, application 300 is the GoodLink™ application developed by Good Technology of Sunnyvale, Calif. At processing block 520, the task 350 claims space in heap 440.

At decision block 530, it is determined whether this launching is the first time the application 300 has been launched. If it is the first time application 300 has been launched, allocator 330 allocates a space in heap 440 to store global variables for application 300, processing block 540. At processing block 550, the global variables stored in global register 410 are copied to the allocated space in heap 440 for the global variables.

Subsequently, the space allocated for these global variables are locked so they cannot be deleted, moved, or modified by the operating system or other components. According to one embodiment, on subsequent launches global registers 410 are modified to point to the global variables in heap 440, which are always in the same place.

At processing block 560, all references are made internal. Typically, when a compiler converts a programmer's code into an application that can run on a computer, there are some decisions that are postponed. For example, the programmer may have coded a jump to a function elsewhere in the code, but the actual address of that function depends on where in memory the program will wind up being stored when it is run. Thus, the compiler cannot “hard-code” the jump.

Instead, the compiler writes a relative value into the program, and marks the location of the relative value as being one is to be updated when the application is launched. Upon being allocated to the global space, the startup code of startup module 310 updates all of the marked relative values based on the actual location of objects for the particular launch. According to one embodiment, this update is done via functions that take the values of parameters from global registers 410.

At processing block 570, database 420 is opened. According to one embodiment, database 420 is opened with a flag that indicates that database 420 is not to be closed. At processing block 580, the global “new” operator is overridden.

Typically, C++ programs allocate memory via calls to operator new. Development environments provide a default implementation of this operator, which calls through, to the native PalmOS allocator MemPtrNew. MemPtrNew returns a chunk of memory, which is tagged in such a way that the OS will be able to find and delete it as soon as the application that requested the allocation exits.

According to one embodiment, the operator new is overridden so that all allocations in application 300 are routed through allocator 330. This is the mechanism through which all memory allocations performed by application 300 are automatically locked down. Otherwise, if the built-in “new” operator were used, memory allocations would not automatically be locked, and therefore those allocations might be able to be automatically deleted or moved when application 300 exited.

The above process enables the multiple tasks 350 (e.g., task 1 and task 2) to remain open in the background of device 100 while a foreground application is running. While task 1 is running, a timer is running. The timer is an OS service that provides a signal to task scheduler 360 indicating when a particular task 350 is to yield to another task 350. According to one embodiment, the timer is a counter that transmits a signal to task scheduler 360 upon reaching a predetermined count.

Once timer 320 times out, a signal is transmitted and task 1yields control to task 2, or the PalmOS scheduler to enable the foreground application to gain control. As a result, task 2 calls PilotMain of application 300. However in one embodiment, PilotMain is called in this instance such that no global variables are passed.

Because GoodLink has modified startup code in the manner described above the global variables are restored to their state as they existed the last time that application 300 had exited. Further, since all of the memory that application 300 had previously allocated was locked, it has not changed since last launch.

Moreover, because all databases that application 300 had previously opened were flagged to remain open, they are in the same state as when application 300 last exited. In addition, all pointer references to the application 300 code remains valid because all of the code was flagged to be locked down (e.g., not movable).

This combination allows application 300 to pick up from its previous state even in this case where its PilotMain has been called (“sublaunched” or “background launched”) without global variables. Thus, task 1 can call scheduler 360without global variables, indicating to scheduler 360 that it is seeking a background launch.

Upon receiving the call from task 1, the startup code within startup module 310 alerts the OS to point to the modified global variables in the task 1 space in heap 440. Subsequently, task 1 runs in the background while the device 10 user is still operating the foreground application. When task 1 has had control for a predetermined time, task 1 yields to task 2, or the PalmOS scheduler. Scheduler 360 restores the original global variables stored in global register 410 and backs out of the task 1 background launch. Thus, control is returned back to task 2 or PalmOS.

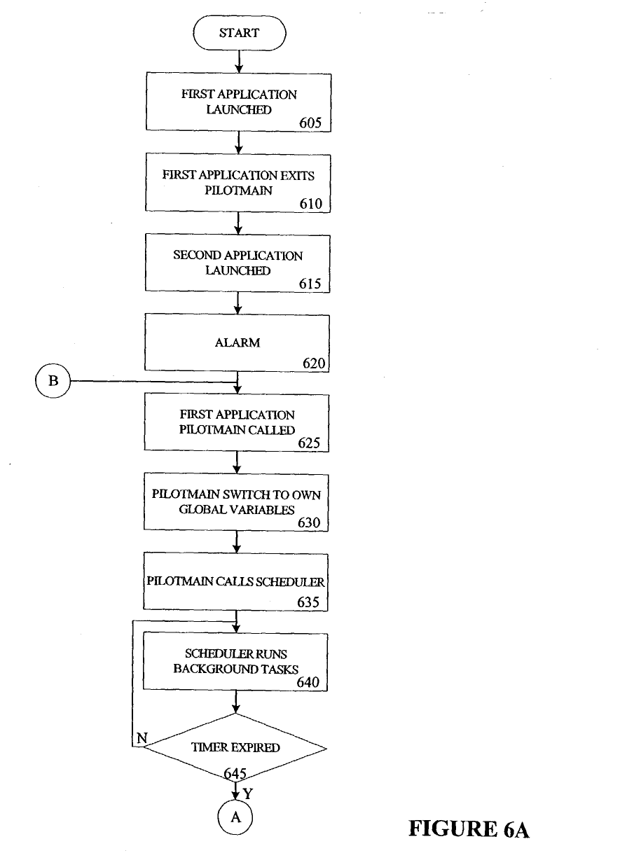

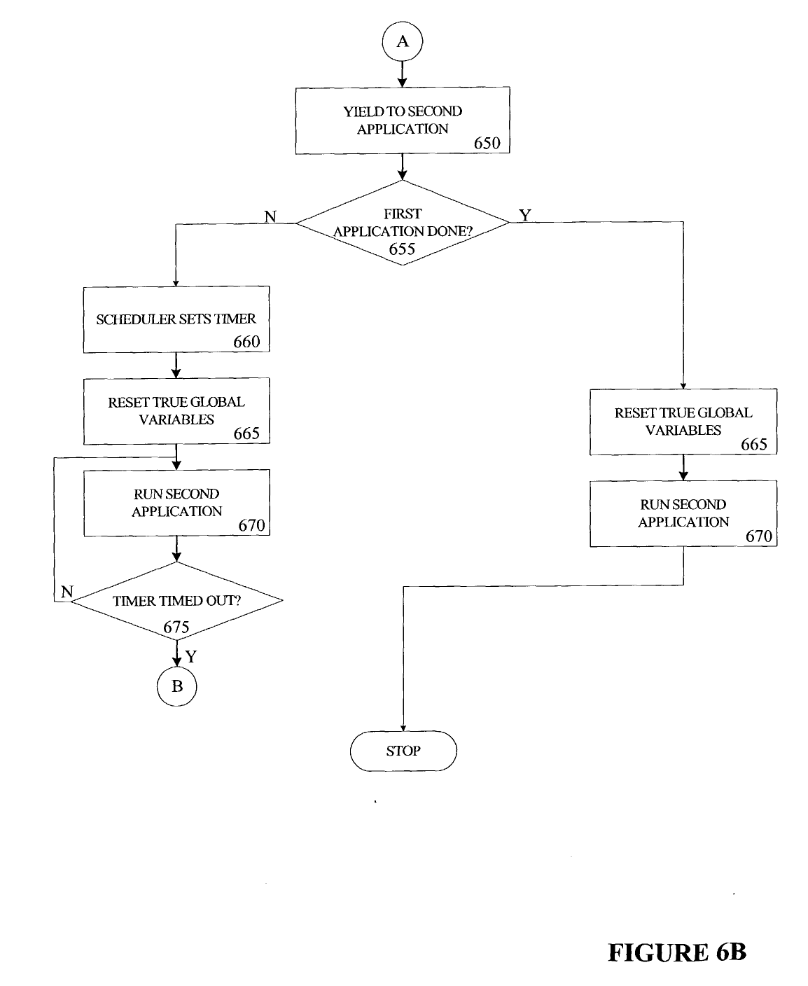

FIGS. 6A and 6B illustrate a flow diagram for one embodiment of the operation of a handheld device 100 while operating an application 300 (e.g., GoodLink) in the background while a second application such as a calculator is running. GoodLink is a wireless messaging system that enables handheld device 100 to have continuous synchronization with a home system; thus providing access to email, secure attachments, contacts, calendar, notes and tasks.

Referring to FIG. 6A. The GoodLink application starts at processing block 605. Consequently, GoodLink is called at its PilotMain for the first time. At processing block 610, GoodLink exits PilotMain, first setting an alarm with the OS. At processing block 615, the calculator application is launched (e.g., PalmOS calls the calculator's PilotMain). At processing block 620, the alarm fires.

At processing block 625, GoodLink is launched in the background via a call to its alarm procedure (which it installed when setting the alarm above). The alarm procedure is the procedure within the GoodLink application that is called by the operating system when its alarm fires. This time, no global variables are set up for GoodLink. At processing block 630 GoodLink's alarm proc switches to GoodLink's global variables stored in heap 440.

At processing block 635, GoodLink's alarm proc calls scheduler 360. At processing block 640, GoodLink schedules one or more of its background tasks 350 (e.g., to decrypt an already-received message, check for network traffic, etc). As a result GoodLink begins to do some of its background work, such as decrypting a portion of the received message.

At decision block 645, the current GoodLink background task determines if it has run long enough if GoodLink has not run long enough, control is returned to processing block 640 where scheduler 360 continues to run GoodLink in the background. If GoodLink has had control for a sufficient amount of time, GoodLink yields.

Subsequently, scheduler 360 decides to return control to the OS. However, before exiting the alarm proc, scheduler 360 sets another alarm with the OS and restores the global state for the calculator application. Scheduler 360 then exits. According to one embodiment, if there is no more work to do, scheduler 360 may set a much longer-term alarm, or even not to set one at all.

Referring to FIG. 6B, GoodLink yields to the calculator application at processing block 650. At decision block 655, it is determined whether the background task 350 has been completed (e.g., GoodLink has completed its task of decrypting the message). If the task has not been completed, scheduler 360 sets timer 320, processing block 660. At processing block 665, the true global variables are reset, and GoodLink PilotMain is exited.

At processing block 670, control is returned to the calculator application. At processing block 675, it is determined whether timer 320 has timed out. If timer 320 has not timed out, control is returned to processing block 670 where scheduler 360 continues to run the calculator application. If timer has timed out, the alarm signal is transmitted to scheduler 360 and the calculator application yields to GoodLink. Consequently, control is returned to processing block 625 (FIG. 6A) where GoodLink is launched in the background by calling PilotMain.

Returning back decision block 655, if it is determined that GoodLink has completed its task of decrypting the message (in this example), the true global variables are reset, and GoodLink PilotMain is exited, processing block 665. Subsequently, control is returned to the calculator application at processing block 670.

Although the above-described embodiment illustrates GoodLink running as a background application, and a calculator as a foreground application, one of ordinary skill in the art will appreciate that the present invention may be implemented using other time dependent and non time dependent applications. Moreover, this invention may be implemented with simultaneously operating time dependent applications.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention. Thus, a method for running a time dependent application in the background of second application in a PalmOS has been described.

1. A method comprising:
launching a first application at a handheld device implementing a Palm Operating System (OS); and
launching a second application, wherein the second application runs in the background of the first application.

2. The method of claim 1, wherein launching the second application comprises:
determining if the second application has previously been launched; and
allocating space in memory if the second application has not previously been launched.

3. The method of claim 2, further comprising:
copying global variables from a space pointed to by a register to the allocated space in memory; and
opening and database.

4. The method of claim 1, further comprising receiving a time dependent event prior to launching the second application.

5. The method of claim 4, wherein launching the second application comprises:
referencing global variables stored in memory allocated for the second application;
requesting access for operation; and
yielding operation from the first application to the second application.

6. The method of claim 5, further comprising:
determining if a timer has expired; and
yielding operation from the second application to the first application if the timer has expired.

7. The method of claim 5, further comprising:
determining if execution of the time dependent event has been completed;
restoring global variables referencing to global variables stored in a global register if execution of the time dependent event has been completed; and
yielding operation from the second application to the first application.

8. The method of claim 7, further comprising:
enabling a timer if execution of the time dependent event has not been completed;
restoring global variables referencing to global variables stored in a global register; and
yielding operation from the second application to the first application.

9. The method of claim 8, further comprising:
determining if the timer has expired; and
yielding operation from the first application to the second application if the timer has expired.

10. A handheld device comprising:
a first application that operates according to a Palm Operating System (OS); and
a second application that operates according to the PalmOS and is operable to operate in the background of the first application.

11. The handheld device of claim 10, wherein the second application comprises:
one or more tasks corresponding to operations to be performed by the second application; and
a task scheduler to schedule operation time for the first application and each of the one or more tasks.

12. The handheld device of claim 11, wherein the second application further comprises
a startup module to launch the second application; and
an allocator to allocate an area in memory for storage of global variables for the second application.

13. The handheld device of claim 12, further comprising:
global registers to store global variables for the first application; and
databases.

14. The handheld device of claim 13, further comprising:
program code associated with each of the one or more tasks;
a memory heap to store data associated with each of the one or more tasks; and
one or more stacks corresponding to each of the one or more tasks.

15. The handheld device of claim 14 wherein each of the one or more tasks manages an allocated space in the memory heap.

16. The handheld device of claim 14, wherein the startup module is configured saves the state of the global variables, the stack corresponding to each task, and the memory heap allocated to that the global variables, the stacks and the memory heap cannot be moved by the PalmOS.

17. The handheld device of claim 16, wherein the startup module is further configured to save the program code associated with each task of the second application in order to maintain the same location in memory.

18. The handheld device of claim 16, wherein the startup module is further configured to maintain all databases in an open state.
